(19) United States
(12) Patent Application Publication
(10) Pub. No.: US 2006/0250425 A1
(43) Pub. Date: Nov. 9, 2006

(54) Method and system for detecting low ink levels in a printing system and replacing ink cartridge without stopping printing operations

(75) Inventors: Easwaran Nambudiri, Rye Brook, NY (US); John P. Miller, Shelton, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/120,858

(22) Filed: May 3, 2005

(51) Int. Cl. B41J 2/195

(52) U.S. Cl. 347/7

(57) ABSTRACT

Methods and systems that can detect low ink levels in an ink supply and that allows replacement of the ink supply without having to stop the printing operations. A printing system is provide with a sub-tank from which the print head receives ink. A removable ink tank supplies ink to the sub-tank. The removable ink tank is provided with a memory device to store information associated with the ink tank. A sensor is provided in the sub-tank from which the amount of ink in the sub-tank can be determined. The system reads the memory device on the ink tank and monitors the sensor in the sub-tank to determine operating conditions for the system. The ink tank can be replaced without having to stop the printing process.

### FIELD OF THE INVENTION

The invention disclosed herein relates generally to mailing systems, and more particularly to a method and system for detecting low ink levels and replacing an ink cartridge without stopping printing operations in high speed mail processing systems that utilize ink jet printers for printing indicia and other information on mail pieces.

### BACKGROUND OF THE INVENTION

Mail processing systems for preparing mail pieces, e.g., stuffing envelopes, and/or printing postage indicia on envelopes and other forms of mail pieces have long been well known and have enjoyed considerable commercial success. There are many different types of mail processing systems, ranging from relatively small units that handle only one mail piece at a time, to large, multi-functional units that can process thousands of mail pieces per hour in a continuous stream operation. The larger mailing machines often include different modules that automate the processes of producing mail pieces, each of which performs a different task on the mail piece. The mail piece is conveyed downstream utilizing a transport mechanism, such as rollers or a belt, to each of the modules. Such modules could include, for example, a singulating module, i.e., separating a stack of mail pieces such that the mail pieces are conveyed one at a time along the transport path, a moistening/sealing module, i.e., wetting and closing the glued flap of an envelope, a weighing module, and a metering module, i.e., applying evidence of postage to the mail piece. The exact configuration of the mailing machine is, of course, particular to the needs of the user.

Typically, a control device, such as, for example, a microprocessor, performs user interface and controller functions for the mail processing system. Specifically, the control device provides all user interfaces, executes control of the mail processing system and print operations, calculates postage for debit based upon rate tables, provides the conduit for the Postal Security Device (PSD) to transfer postage indicia to the printer, operates with peripherals for accounting, printing and weighing, and conducts communications with a data center for postage funds refill, software download, rates download, and market-oriented data capture. The control device, in conjunction with an embedded PSD, constitutes the system meter that satisfies U.S. information-based indicia postage meter requirements and other international postal regulations regarding closed system meters.

Modern mail processing systems utilize digital printing techniques for producing images on a mail piece. Conventional digital printing techniques include bubble jet and ink jet, each of which produces an image in a dot matrix pattern. With digital printing, individual print head elements (such as resistors or piezoelectric elements) are selectively electronically stimulated to expel drops of ink from an ink supply onto a substrate, e.g., a mail piece. In either case, by controlling the timing of energizing of the individual print head elements in conjunction with the relative movement between the print head and the mail piece, a dot matrix pattern is produced in the visual form of the desired image. In the case of mail processing systems, the image may be, for example, an indicium that evidences payment of postage.

The use of a digital printing technology in mail processing systems, however, presents other issues that must be taken into consideration. For example, replacement or replenishment of the ink supply is required to ensure that continued satisfactory printing occurs. Due to the inherent nature of printing indicia of value (a postal indicium being the equivalent of money), it is desirable to avoid running out of ink while printing a postal indicium. If a postage printing device runs out of ink while printing a postal indicium, the user loses money because the postal funds associated with that postal indicium cannot be recovered. This is not the case with a general purpose ink jet printer, in which the user can simply install a new ink cartridge and reprint the document if the printer runs out of ink while printing. Thus, several methods have been devised to ensure that a user is given sufficient notice before the ink supply runs out of ink such that the ink supply can be replenished. Such methods include drop counting, in which a running total of the number of ink drops ejected by the print head is maintained and continuously compared to a predetermined number of ink drops the ink supply contains, and optical sensors or conductive electrodes in an ink supply structure to provide an indication when the ink level in the ink supply reaches a predetermined threshold level.

While each of the above solutions for determining when to replace an ink supply generally works well, they each present serious limitations when used in high speed printing devices. One such limitation is that each time the ink supply must be replaced, the printing process must be stopped to allow removal of the empty ink supply and insertion of the renewed ink supply. In high speed mail processing systems that can process mail pieces at rates up to 20,000 mail pieces per hour, even very short periods of down-time for maintenance, e.g., replenishing the ink supply, can significantly impact the throughput of the system. For example, halting a system that typically processes 20,000 pieces per hour for only two minutes will reduce the throughput by 733 pieces per hour. If the maintenance is required to be performed several times per day, the throughput of the machine will be decreased by thousands of pieces per day. It would be desirous to have a method and system that does not require the printing process to be halted when replacing the ink supply in such high speed printing applications. It would also be desirous to have a method and system that ensures that replacement ink tanks contain ink that is suitable for use with the printing application.

Thus, there exists a need for a method and system that can detect low ink levels in an ink supply, allows replacement of the ink supply without having to stop the printing operations, and ensures compatibility of the replacement ink supply.

### SUMMARY OF THE INVENTION

The present invention alleviates the problems associated with the prior art and provides methods and systems that can detect low ink levels in an ink supply and that allows replacement of the ink supply without having to stop the printing operations.

In accordance with embodiments of the present invention, a printing system is provided with a sub-tank from which the print head receives ink. A removable ink tank supplies ink to the sub-tank. The removable ink tank is provided with a memory device to store information associated with the ink tank. A sensor is provided in the sub-tank from which the amount of ink in the sub-tank can be determined. The system reads the memory device on the ink tank and monitors the sensor in the sub-tank to determine one of three operating conditions for the system: a normal operating condition (in which printing is allowed), a low-ink condition (in which a limited number of print cycles are allowed, the user is provided with a warning signal, and the ink tank can be replaced) or an ink-out condition (in which no printing may be performed). The sub-tank allows the ink tank to be replaced without having to stop the printing process. Additionally, when the ink level within the sub-tank falls below some predetermined amount, the number of print cycles is counted and the printing process will be suspended after a predetermined number of print cycles have occurred, thereby preventing the loss of funds due to the improper printing of postage indicia. Utilizing the memory device on the ink tank, the system will also ensure that a replacement ink tank that is inserted into the system is a suitable replacement with respect to the ink contained therein, thereby preventing loss of funds due to the use of an improper or inferior ink.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate a presently preferred embodiment of the invention, and together with the general description given above and the detailed description given below, serve to explain the principles of the invention. As shown throughout the drawings, like reference numerals designate like or corresponding parts.

FIG. 1 illustrates in block diagram form a portion of a mail processing system according to an embodiment of the present invention; and

FIG. 2 illustrates in flow diagram form the operation of the mail processing system of FIG. 1 according to an embodiment of the present invention.

### DETAILED DESCRIPTION OF THE PRESENT INVENTION

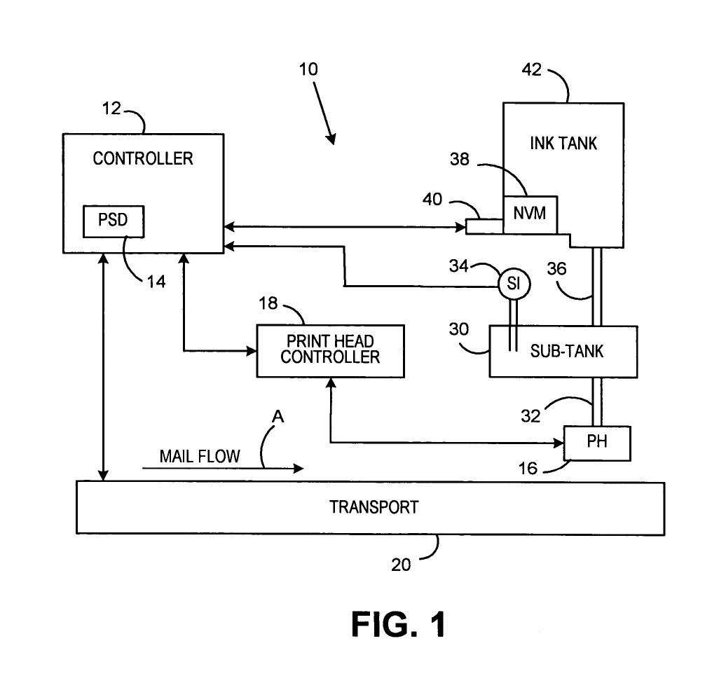

In describing the present invention, reference is made to the drawings, wherein there is seen in FIG. 1 a portion of a mail processing system 10 according to an embodiment of the present invention. It should be noted that while the following description is being made with respect to a mail processing system, the present invention is not so limited and can be utilized in any type of document printing system. System 10 includes a control unit, referred to herein as controller 12, that preferably includes one or more controller units, such as, for example, a microprocessor, general or special purpose processor or the like, to control operation of the mail processing system 10. Specifically, the controller 12, in conjunction with one or more other processors or controllers (not shown), provides all user interfaces, executes control of the mail processing system 10, calculates postage for debit based upon rate tables, provides the conduit for an associated Postal Security Device (PSD) 14 to transfer postage indicia for printing, operates with peripherals for accounting, printing and weighing, and conducts communications with a data center for postage funds refill, software download, rates download, and market-oriented data capture. The PSD 14, which is preferably embedded in the controller 12, contains one or more registers that store the accounting information concerning usage, such as, for example, an ascending register, descending register, piece count register, and the like. The controller 12, in conjunction with the embedded PSD 14, provides the system meter that satisfies U.S. and international postal regulations regarding closed system information-based indicia postage (IBIP) meters.

Mail processing system 10 further includes a print head 16 that is controlled by a print head controller 18. The print head controller 18 is coupled to the controller 12. The print head controller 18 controls operations of print head 16 related to management of data from the controller 12. Management of the data can include, for example, the decryption (if encrypted when received from the controller 12), grouping, formatting and distribution of data between groups of ink jets in the print head 16, generation of the timing signals necessary for firing the ink jets of the print head 16, collection of usage information of the print head 16, and detection of overheating conditions in the print head 16. Controller 18 (or other suitable controller) can also control operations of print head 16 related to maintenance functions that could include, for example, controlling positioning of the print head 16 to ensure it is in a capped position when not printing, ensuring the print head 16 is capped properly when in the capped position, monitoring the voltages being applied to fire the ink jets of the print head 16, and monitoring for error conditions during operation including improper positioning of the print head 16, overheating of the print head 16, etc. It should be noted that the print head controller 18 and the print head 16 may be integrated into a single unit, or alternatively the print head controller 18 may be integral to the controller 12.

Mail processing system 10 further preferably includes a transport 20 that can include, for example, rollers and/or belts, that are utilized to transport mail pieces along a transport path through the mail processing system 10 in the direction indicated by arrow A. The print head 16 is located along the transport path. The transport 20 will transport the mail pieces past the print head 16 such that printing by the print head 16 can occur on each mail piece. Sensors (not shown) located along the transport 20 provide signals to the controller 12 to indicate the position of a mail piece on the transport 20.

According to an embodiment of the present invention, mail processing system 10 includes an ink sub-tank 30 from which the print head 16 receives ink via supply tube 32. The sub-tank 30 is preferably secured within the mail processing system 10 in such a manner that it is not intended to be removable by the user. The sub-tank 30 includes a sensor S1 34 that can sense the amount of ink contained within the sub-tank 30. Sensor 34 can be, for example, any type of optical sensor, conductive electrodes, or any other type of sensor that provides a signal to the controller 12. The controller 12, based on the signal from the sensor 34, can determine when the amount of ink contained in the sub-tank 30 is below some predetermined threshold level. The sub-tank 30 receives ink from a removable ink tank 42 via a supply tube 36. The ink tank 42 includes a memory device, such as a non-volatile memory (NVM) device 38, that stores information about the ink tank 42, including, for example, a serial or identification number, size of the ink tank, etc. When the ink tank 42 is properly inserted into a holding device (not shown) of the mail processing system 10, the NVM 38 mates with a connector 40 that is coupled to a controller, such as, for example controller 12, thereby allowing data to be written into and read from the NVM 38 as will be described below.

Mail processing system 10 according to the present invention includes several advantageous features with respect to printing operations and the supply of ink. Specifically, the ink tank 42 can be replaced without having to stop the printing process. Additionally, when the ink level within the system 10 is nearly depleted, the printing process will be suspended, thereby preventing the loss of funds due to the improper printing of postage indicia. The mail processing system 10 will also ensure that a replacement ink tank 42 that is inserted into the mail processing system 10 is a suitable replacement with respect to the ink contained therein, thereby preventing loss of funds due to the use of an improper or inferior ink.

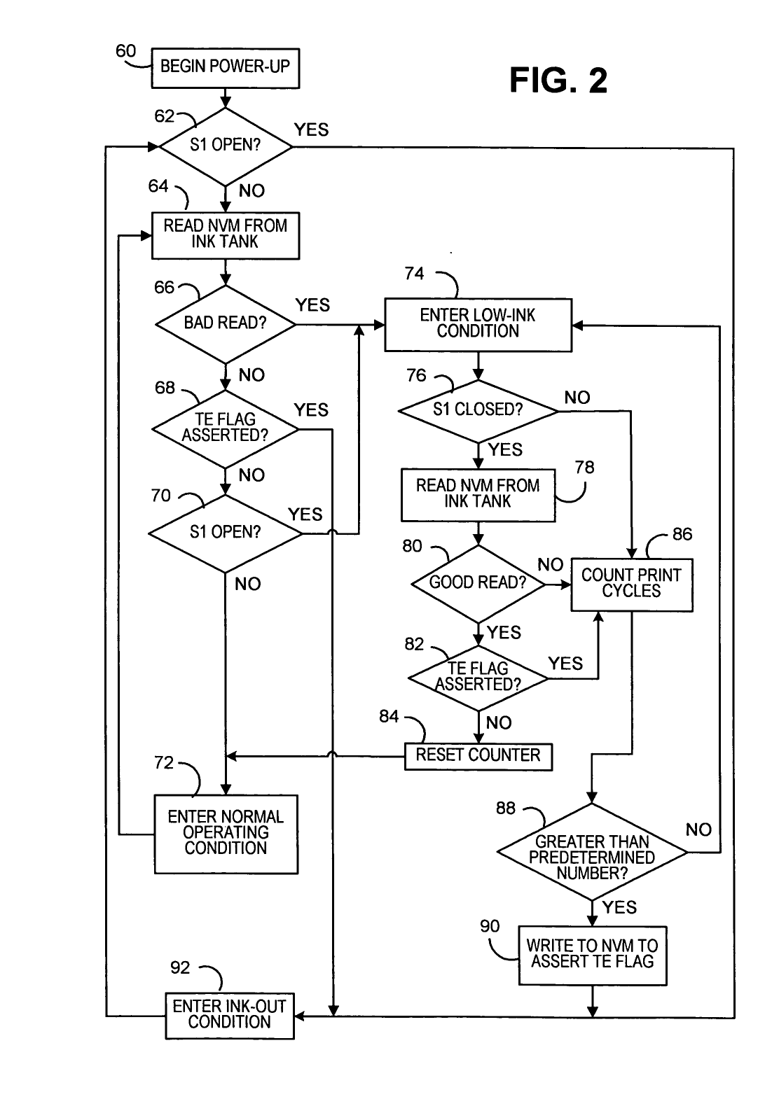

FIG. 2 illustrates in flow diagram form the operation of mail processing system 10 according to an embodiment of the invention. In step 60, power is provided to the mail processing system 10, such as, for example, the system 10 being turned on. In step 62, it is determined if ink in the sub-tank 30 has fallen below a predetermined threshold amount, such as, for example, by determining if sensor S1 34 is open. Sensor 34 will be open if the ink in the sub-tank 30 has fallen below the predetermined threshold amount. If it is determined in step 62 that sensor 34 is open, indicating that although there may still be some ink remaining in the sub-tank 30, it is below the predetermined threshold and therefore the exact amount remaining is unknown, then the system 10 will enter an ink-out condition in step 92. In an ink-out condition, the controller 12 will prohibit any printing from occurring, thereby ensuring that no funds are associated with an indicium that will not be properly printed (due to a lack of ink) and therefore lost. Once an ink-out condition is entered in step 92, the condition of sensor 34 will continue to be monitored until it is determined that sensor 34 is closed in step 62. Sensor 34 will close when the ink level in the sub-tank 30 is above the predetermined threshold. This can occur, for example, if the user replaces the ink tank 42 with a new ink tank, thereby refilling the sub-tank 30 with ink.

Once it is determined in step 62 that sensor 34 is not open (meaning the ink level in the sub-tank 30 is above the threshold level), then in step 64 the NVM 38 from the ink tank 42 inserted into the system 10 is read by, for example, the controller 12. In step 66 it is determined if there is a bad read, i.e., if any of the data read, or attempted to be read, from the NVM 38 is unacceptable or differs from an expected value. There are several situations that can cause a bad read of the NVM 38 to occur. For example, if the ink tank 42 inserted into the system 10 does not have an NVM, either because it was removed from an authorized ink tank or the ink tank is not an authorized ink tank, a bad read will occur. If there is a suitable NVM 38, a bad read can be caused by an improper identification number read from the NVM, indicating the ink tank is not an authorized ink tank for use with the system 10. It should be understood that any type of information can be stored in the NVM 38, and the system 10 can compare the information read from the NVM 38 with information expected to be read to determine if the ink tank 42 inserted into the system 10 is an authorized ink tank. If it is determined in step 66 that there is not a bad read, then in step 68 it is determined if a Tank Empty (TE) flag is asserted in the NVM 38. The TE flag will be asserted once an ink tank has been utilized for some predetermined number of print cycles, thereby indicating that the ink in the tank has been depleted. If in step 68 it is determined that the TE flag is asserted, indicating that the ink tank 42 was at some point previously emptied, then the system 10 will enter the ink-out condition in step 92. The use of the TE flag protects the system 10 from having an ink tank 42 that was refilled by an unauthorized party from being reused in the system 10. This ensures that the ink tank 42 contains only quality ink that is suitable for the intended purpose. In many instances, refill inks sold by unauthorized parties to refill the ink tank 42 can cause several problems, including clogging of print nozzles in the print head 16, poor quality leading to unreadable images, etc.

If in step 68 it is determined that the TE flag is not asserted, then in step 70 it is again determined if sensor 34 is open. If it is determined in step 70 that sensor 34 is not open, then in step 72 the system 10 will enter a normal operating condition in which printing operations can be performed, since it has been determined that there is sufficient ink in the sub-tank 30, and the ink tank 42 is properly inserted into the system, is an authorized ink tank and is not already empty. The operation then returns to step 64 to repeat the reading of the NVM 38 and monitoring of the sensor 34.

If in step 66 it is determined that a bad read has occurred (such as, for example, if the ink tank 42 were removed by the user), or if in step 70 it is determined that the sensor 34 is open (indicating the ink level in the sub-tank 30 has fallen below the predetermined threshold level), then in step 74 the system 10 will enter a low-ink condition. In a low-ink condition, printing is allowed to continue similarly as in the normal operating condition, but a warning signal is generated by the controller 12 and provided to the user in either an audio and/or visual manner, such as, for example, on a display of the system 10. The warning signal preferably indicates to the user that there is either a problem with the ink tank 42, e.g., it is not inserted properly or has been removed, or the ink tank 42 may need to be replaced to replenish the ink supply. Once a low-ink condition has been entered in step 74, then in step 76 it is determined if sensor 34 is now closed. This could be caused, for example, in situations in which the user did not properly insert the ink tank 42, wherein the user reacts to the warning signal provided in step 74 and re-inserts the ink tank 42 or possibly inserts a new ink tank 42. If in step 76 it is determined that sensor 34 is not closed, meaning that the ink level in the sub-tank 30 is below the predetermined threshold, then in step 86 the number of print cycles performed by the print head 16 will be counted as described below.

If in step 76 it is determined that the sensor 34 is closed, indicating that the ink level in the sub-tank 30 is above the predetermined threshold, then in step 78 the NVM 38 from the ink tank 42 is read. In step 80, it is determined if there is a good read of the NVM 38, i.e., if the data has been properly read and is acceptable (similarly as described above with respect to step 66). If in step 80 it is determined that there is a good read of the NVM 38, then in step 82 it is determined if the TE flag in the NVM 38 is asserted. This could be caused, for example, by the user replacing the ink tank 42 with an ink tank that was previously emptied and refilled by an unauthorized party. If in step 80 it is determined that either the data was unable to be read or was not acceptable (indicating, for example, that there is no ink tank 42 inserted or it is not an authorized ink tank) or if in step 82 it is determined that the TE flag is asserted (indicating an unauthorized refilled ink tank), the only ink known to be appropriate remaining in the system 10 is in the sub-tank 30 and in step 86 the number of print cycles performed by the print head 16 will be counted. Such counting can be performed, for example, by software or hardware within the print head controller 18. When sensor 34 opens during operation of the system 10 (other than if detected immediately upon power-up in step 62), there is a bad read of the NVM 38 during operation of the system 10 (indicating, for example, that there is no ink tank 42 to supply ink to the sub-tank 30), or the TE flag in the NVM 38 read is asserted (indicating, for example, an ink tank 42 that has not been properly refilled has been inserted into the system 10), the amount of ink remaining in the sub-tank 30 can be estimated with a high degree of certainty, i.e., the amount of ink remaining is at least just less than the predetermined threshold at which the sensor 34 is set to open. It is possible, therefore, to determine the amount of print cycles that can still be performed with the ink remaining in the sub-tank 30, since the amount of ink used for each print cycle is known. For example, once the low ink condition is entered in step 74, there could be at least enough ink remaining in the sub-tank 30 to perform 5,000 print cycles. Of course, this number could be set as desired based on the level at which the sensor 34 is set to open. This means that the system 10 can continue to operate in the low-ink operating condition, i.e., allow printing operations to occur, for another 5,000 printing cycles. In step 88 it is determined if the number of print cycles performed is greater than the predetermined number of print cycles remaining, e.g., 5,000. If the number of print cycles is not greater than the predetermined number of print cycles remaining, then in step 74 the system 10 will remain in the low-ink condition, and continue to loop through the reading of the NVM 30, checking of the sensor 34 and counting of the print cycles as described above.

The system 10 will remain in the low-ink condition until the predetermined number of print cycles, e.g., 5,000, have been performed or the sensor 34 closes, there is a good read of the NVM 38, and the TE flag in the NVM 38 is not asserted. In step 88 it is determined if the number of counted print cycles is greater than the predetermined number of print cycles remaining. Once this point has been reached, it indicates that the amount of ink remaining in the sub-tank 30 is almost depleted, and there is no ink tank 42 inserted in the system 10 or the ink tank 42 inserted in the system 10 is empty, as it is no longer providing ink to the sub-tank 30. In step 90, the TE flag in the NVM 38 of the ink tank 42 inserted in the system 10 will be asserted, thereby indicating that the ink tank 42 has been emptied. This can be done, for example, by the controller 12. The system 10 will then enter an ink-out condition in step 92 as described above.

At any time during the low-ink condition operation, the reason that caused the low-ink condition to be entered can be corrected. For example, if the ink tank 42 was not properly inserted, causing a bad read of the NVM 38, it can be re-inserted. If the ink level in the sub-tank 30 was too low, a new ink tank 42 with a fresh supply of ink may be inserted, thereby raising the level of ink in the sub-tank 30. When sensor 34 is closed in step 76, there is a good read of the NVM 38 in step 80, and the TE flag is not asserted in step 82, this indicates that there is an authorized ink tank 42 (that was not previously emptied) installed in the system, and the amount of ink in the sub-tank 30 is above the predetermined threshold. In step 84, therefore, the counter can be reset as there is no longer a limited number of print cycles that can be performed until the sub-tank 30 is depleted of ink, and the system 10 can return to a normal operating condition in step 72. The system will remain in the normal operating condition until there is either a bad read of the NVM 38 (in step 66) or the sensor 34 opens (in step 70), at which point the low-ink condition will be entered (step 74).

Thus, the system 10 will continue to operate in either a normal operating condition (in which printing is allowed), a low-ink condition (in which a limited number of print cycles are allowed, the user is provided with a warning signal, and the ink tank 42 can be replaced) or an ink-out condition (in which no printing may be performed). By looping through the processing as illustrated in FIG. 2, the operating condition will change as appropriate. Thus, mail processing system 10 according to the present invention includes several advantageous features with respect to printing operations and the supply of ink. Specifically, use of the sub-tank 30 allows the ink tank 42 to be replaced without having to stop the printing process. Additionally, when the ink level within the sub-tank 30 falls below some predetermined amount, the number of print cycles is counted and the printing process will be suspended after a predetermined number of print cycles have occurred, thereby preventing the loss of funds due to the improper printing of postage indicia. The mail processing system 10 will also ensure that a replacement ink tank 42 that is inserted into the mail processing system 10 is a suitable replacement with respect to the ink contained therein, thereby preventing loss of funds due to the use of an improper or inferior ink.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description.

What is claimed is:

1. A method of operating a printing system including a print head, an ink sub-tank to supply ink to the print head, and a removable ink tank to supply ink to the sub-tank, the removable ink tank including a memory device to store information associated with the removable ink tank, the method comprising:
reading at least a portion of the information associated with the removable ink tank from the memory;
determining if ink in the sub-tank is below a predetermined threshold;
determining if the information associated with the removable ink tank read from the memory is acceptable;
if the information associated with the removable ink tank read from the memory is acceptable and the ink in the sub-tank is not below the predetermined threshold, entering a first operating condition in which print operations can be performed by the print head;
if the information associated with the removable ink tank read from the memory differs from an expected value or the ink in the sub-tank is below the predetermined threshold, entering a second operating condition in which print operations can be performed by the print head and a signal is provided to a user indicating a low-ink operating condition; and
continuing to operate in the second operating condition for a predetermined number of print cycles, even if the removable ink tank is removed from the printing system, or until the information associated with the removable ink tank read from the memory is acceptable and the ink in the sub-tank is not below the predetermined threshold.

2. The method of claim 1, wherein continuing to operate in the second operating condition for a predetermined number of print cycles further comprises:
counting a number of print cycles performed;
determining if the number of print cycles performed is greater than the predetermined number;
if the number of print cycles performed is greater than the predetermined number, entering into a third operating condition in which further printing operations are prohibited.

3. The method of claim 2, wherein the number of print cycles performed is counted using a counter, and during the counting of the number of print cycles performed the reading of at least a portion of the information associated with the removable ink tank from the memory, the determining if the information associated with the removable ink tank read from the memory is acceptable, and the determining if ink in the sub-tank is below the predetermined threshold are repeated, and if the information associated with the removable ink tank read from the memory is acceptable and the ink in the sub-tank is not below the predetermined threshold, the method further comprises:
resetting the counter; and
returning to the first operating condition in which print operations can be performed by the print head.

4. The method of claim 2, wherein entering into a third operating condition further comprises:
writing to the memory device to indicate the ink tank has been emptied.

5. The method of claim 1, wherein determining if the information associated with the removable ink tank read from the memory is acceptable further comprises:
determining if the ink tank has previously been emptied based on information stored in the memory.

6. The method of claim 5, wherein if the ink tank has previously been emptied, the method further comprises:
entering into a third operating condition in which further printing operations are prohibited.

7. The method of claim 1, wherein the printing system is a mail processing system for printing on mail pieces.

8. A printing system comprising:
a print head for printing on a medium;
an ink sub-tank coupled to the print head, the sub-tank providing ink to the print head during printing operations, the sub-tank including a sensor for providing signals based on an amount of ink in the sub-tank;
a removable ink tank coupled to the sub-tank, the removable ink tank providing ink to the sub-tank, the removable ink tank including a memory device for storing information associated with the removable ink tank;
means for reading at least a portion of the information associated with the removable ink tank from the memory and determining if the information associated with the removable ink tank read from the memory is acceptable; and
means for determining, based on the signals from the sensor, if ink in the sub-tank is below a predetermined threshold,
wherein if the information associated with the removable ink tank read from the memory is acceptable and the ink in the sub-tank is not below the predetermined threshold, the printing system will operate in a first operating condition in which print operations can be performed by the print head, and if the information associated with the removable ink tank read from the memory differs from an expected value or the ink in the sub-tank is below the predetermined threshold, the printing system will operate in a second operating condition in which print operations can be performed by the print head and a signal is provided to a user indicating the low-ink operating condition for a predetermined number of print cycles, even if the removable ink tank is removed from the printing system, or until the information associated with the removable ink tank read from the memory is acceptable and the ink in the sub-tank is not below the predetermined threshold.

9. The system of claim 8, further comprising:
a counter for counting a number of print cycles performed; and
means for determining if the number of print cycles performed is greater than the predetermined number,
wherein if the number of print cycles performed is greater than the predetermined number, the printing system will operate in a third operating condition in which further printing operations are prohibited.

10. The printing system of claim 8, wherein the printing system is included in a mail processing system.
